(19) United States
(12) Patent Application Publication
(10) Pub. No.: US 2004/0215348 A1
(43) Pub. Date: Oct. 28, 2004

(54) Tie-line flow control system and method for implementing inter-regional transactions

(76) Inventors: Marija D. Ilic, Cambridge, MA (US); Yong T. Yoon, Cambridge, MA (US)

Correspondence Address: Sam Pasternack, Choate Hall & Stewart, Exchange Place, 53 State Street, Boston, MA, 02109-2891, US

(21) Appl. No.: 09/688,294

(22) Filed: Apr. 9, 2001

(51) Int. Cl. G06F 17/60; G05B 15/00

(52) U.S. Cl. 700/1; 705/35; 705/40; 705/37

(57) ABSTRACT

A tie-line control system and method. Tie-line flow control among selling entities is facilitated by an entity implementing transmission contracts for purchasing entities. The entity will execute the steps of receiving request bid curves for inter-regional transactions from selling entities; receiving demand bid curves for inter-regional transactions from purchasing entities; synchronizing the bid curves at a selected time interval; between synchronizing times, iterating information with the selling and purchasing entities to ensure clearing of supply and demand bids at a clearing time so that tie-line real and reactive power flows on the tie-lines interconnecting the selling entities are the same; communicating to the selling and purchasing entities accepted tie-line flow quantities and corresponding prices at the clearing time; and ensuring that all inter-regional transactions clear as agreed upon in the previous synchronized interval.

### FIELD OF THE INVENTION

The present invention relates to the facilitation of electricity transmission contracts by providing a strict static tie-line control system and method for implementing inter-regional transactions, within the confines of a deregulated power industry.

### BACKGROUND OF THE INVENTION

In the electrical power industry, new structures have evolved from fully integrated utilities with a well-defined obligation to serve their own (native) customers into corporately and functionally separate transmission, generation and load-serving businesses within an electrically connected large transmission network. By law, all these entities are required to provide “open access” transmission services within the interconnection so that inexpensive power produced can be sold to electrically distant customers. Open access requires that the individual transmission providers should serve both their local customers and the far away customers according to the same criteria. Establishing the meaningful criteria for functionally and corporately non-uniform entities is not a straightforward matter. Because of this, the problem of transmission provision under open access is currently considered to be one of the major obstacles to the competition of power producers when attempting to serve customers in a non-traditional way.

Entities such as power pools and utilities in the same geographical area (such as Northeast United States, Western United States, Midwest United States) have cooperated in order to prevent major blackouts in their part of the interconnection. Lessons learned particularly after the Northeast blackouts in the 1960's and 1970's have indicated that it is critical to know the actual exchanges with the adjacent areas as the entities operate to prevent blackouts under the unexpected equipment outages in one's own area. In the 1960's blackout, part of the problem in the New York area was related to drastically different tie-line flow to Canada than assumed as different remedial actions were attempted in response to a generator outage in the New York area.

As a result of this experience, the utilities have organized themselves into reliability coordinating councils. The members of each council perform many off-line scenario studies in order to establish limits on exports/imports among different entities within the council. These limits are often respected by one entity within the council in order not to create technical problems (voltage, stability) within the other utility and/or to avoid region-wide problems, such as inter-area oscillations.

These limits are often quite conservative, mainly because of the widely accepted preventive (N−1) type criteria: For any contingency taking place within the region, no customers should see an interruption for greater than a specified time (say 30 minutes). (North American Electric Reliability Council Operating Manual, February, 2000, http://www.nerc.com) This criterion does not allow for any corrective actions in response to the contingency, such as adjustment of set points for various controllers in the system. The criterion does not allow for partial load shedding, either. A criterion of this type is, therefore, an inefficient method of keeping the system intact under a critical contingency.

Consequently, the amount of reserve required to be maintained at the regional level amounts approximately to the largest source of power, be it an import (via DC line from Canada, for example), or a large power plant within the region. This reserve is jointly shared by all utilities within the region, since it is considerably cheaper to share this burden jointly. Another important lesson from the past is the fact that none of the individual entities by themselves are capable of controlling a large import on a tie-line. For example, if Canada, New York and New England agree to import 1200 MW on a DC line from Canada, this can not be done without the power plants in New York and/or New England adjusting their outputs.

As the industry restructures, there has been much confusion concerning the actual mechanisms and responsibilities for reliable electricity service. The responsibility for reliable service is bounced between the former utilities (local wire providers) and the Independent System Operators that are being formed. Neither type of entity is capable of providing reliable service at the interconnection level as the inter-regional transactions are attempted. In response to this situation, so-called Security Coordinators have been formed (often being of the size of a typical regional reliability council, such as NPCC, MAIN or WSCC) whose main function is to curtail some of the inter-regional transactions in case of a real emergency. One of their functions is so-called Transmission Load Relief (TLR) which is based on denying transactions with the largest negative reliability impact. (NERC Transmission Loading Relief Procedure—Eastern Interconnection, Section G, “Interchange Transaction Reallocation”, North American Electric Reliability Council). There is no economic criteria associated with the TLR actions, resulting in curtailment of often most economic transactions. For this reason, the current TLR procedures have been heavily criticized by the interconnection users such as power marketers, in particular.

Given this overall situation, it is quite clear that is it is essential to have a more systematic understanding and approach to reliability provision under open access.

### SUMMARY OF THE INVENTION

In one aspect, the present invention is a system and method for tie-line flow control among selling entities by enabling a coordinating entity, hereinafter referred to as an Inter-regional Transmission Organization or “IRTO”, to facilitate implementation of transmission contracts for purchasing entities. The IRTO will provide optimal market clearing services within an environment of open access transmission requirements. In an aspect of the system, the IRTO receives requests for inter-regional transactions in the form of request bid curves from selling entities, and in the form of demand bid curves from purchasing entities. Typically, the purchasing entities will comprise Inter-regional Transactions (or “IRTs”), and the selling entities comprise Transmission Providers (or “TPs”), Control Areas (or “CAs”), and Independent System Operators (or “ISOs”). In one embodiment, the selling entities comprise only CAs. At a selected time interval, the IRTO will synchronize the bid curves, and between synchronizing intervals, iterate information with the selling and purchasing entities to ensure clearing of supply and demand bids at a clearing time so that tie-line real and reactive power flows on the tie-lines interconnecting the selling entities are the same. Preferably, the selected time interval for synchronization may be daily, weekly, monthly and/or seasonally, but any time interval is contemplated. The IRTO will communicate to the selling and purchasing entities accepted tie-line flow quantities and corresponding prices at the clearing time. In a preferred embodiment, the system of the present invention will clear the supply and demand bids by application of a clearing algorithm which, subject to a technical flow law based on a Kirchoff Current Law, minimizes the sum of deviations between tie-line flow controlled by the selling entities and tie-line flow caused by all inter-regional transactions, the charge related to the price of tie-line flow set by the selling entities, and the benefit related to the use of the tie-line flows and paid by all the inter-regional transactions. The system of the present invention will also enable the IRTO to monitor and/or ensure that all inter-regional transactions clear as agreed upon in the previous synchronized interval. In one embodiment, the system of the present invention comprises a computer having a central processor that executes instructions, a memory for storing the instructions to be executed, a means for communicating information, and an instruction set for implementing the steps recited above.

A key feature of the present invention is the well-defined information flow between the buyers and sellers of transmission services, physically tractable transmission products (tie line flows, real and reactive) and tariffs with the right incentives to provide a value-based service to the transmission system users. The information flow framework disclosed herein is straightforward to grasp by the power engineers because it is a generalization of a technical concept currently used for automatic generation control (U.S. Pat. No. 4,267,571 to Cohn, the contents incorporated herein by reference), a method developed before open access for addressing small, random fluctuations in demand. However, the generalization is non-trivial and novel as it requires conceptually the introduction of a tertiary level coordinating mechanism for implementing this framework as a super-market on top of the existing electricity markets and industry entities (transmission owners, control areas and/or utilities). The invention disclosed herein provides essential concepts and physical structure for creating either a performance-based regulated entity or fully privatized, for profit entity which is necessary for facilitating implementation of IRT-type contracts under open access transmission requirements.

Another aspect of the invention is a system and method for coordinated reliability management through non-uniform reliability provisions which are a function of the selling entities' regulatory and optimal tariff structure.

### BRIEF DESCRIPTION OF THE DRAWING

The invention is described with reference to the several figures of the drawing, in which,

FIG. 1 is a block diagram illustrating an environment in which the IRTO will operate, displaying directions of information flow.

FIGS. 2A, 2B are transmission provision bidding curves submitted by a selling entity I for the tie-line Tₖₙ^{I} between point k and n over the time interval T.

FIGS. 3A, 3B are transmission capacity purchase bidding curves for proposed inter-regional transaction between points l and m.

FIG. 4 is a schematic diagram of a two control area embodiment, in which areas I and II are interconnected via a tie-line whose flow is F_{I,II}.

FIG. 5 is a time line for receiving and clearing offers for inter-regional transactions.

FIG. 6 is a schematic representation of an injection and withdrawal pair for inter-regional transactions.

FIG. 7 is a graphical representation of typical demand offers by transaction ij.

FIG. 8 is a graphical representation of typical supply curves by each control area (I and II).

FIG. 9 is a block diagram of the IRTO functions.

### DETAILED DESCRIPTION

I. Basic Information Flow

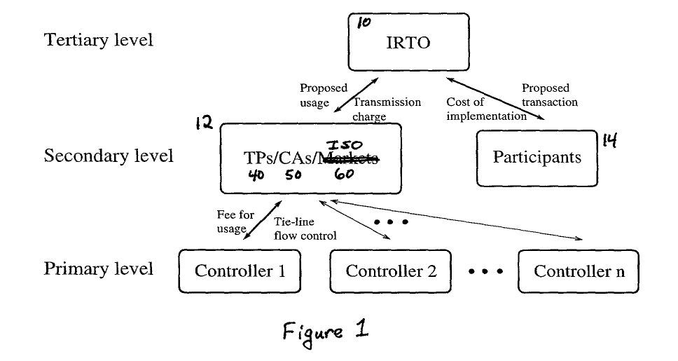

The framework in which an Inter-regional Transmission Organization, or “IRTO” 10, applying the system disclosed herein will operate is shown in FIG. 1. The only information flow is between the IRTO 10 and 1) selling entities 12 comprising Transmission Providers (TPs) 40, Control Areas (CAs) 50, and/or Independent System Operators (ISOs) 60, and 2) purchasing entities 14 (inter-regional transactions) requesting implementation. There is no need for more detailed information exchange between the owners of individual equipment within any selling entities 12 and the IRTO. All products and tariffs are defined at the level of this information flow for purposes of serving inter-regional transmission system users. This reduced information flow resembles that associated with the current implementation of automatic generation control in the United States.

Shown in FIG. 1 are the IRTO 10 and individual providers 12 of transmission service (“selling entities”). A request for inter-regional transaction point-to-point physical implementations may be made to the IRTO by the close of a selected time interval. In order to implement these transactions, sufficient transmission capacity must be made available by the providers of inter-regional transmission access, that is, tie-line flows. In today's industry, providers 12 of transmission service comprise 1) vertically integrated utilities (with their control centers responsible for serving local (or “native”) customers reliably), and making the remaining available transfer capability (ATC) available to outside transactions, 2) Independent System Operators (ISOs) 60 implementing electricity market requests by users located both inside in the area and outside, 3) Control Areas (CAs) 50 without any scheduling coordinator of transactions, and 4) transmission providers (TPs) 40 functionally and corporately separated from the energy market, making their wires available to use at a charge, etc. Depending on the part of the country where an IRTO 10 is implemented, the area will be either dominated by ISOs 60 (Northeast United States comprising NE-ISO, NY-ISO, PJM-ISO), or by a group of CAs 50, facilitating bilateral transactions (Alliance), or a combination of the two (Western United States, with CA-ISO and several adjacent CAs), or by individual transmission owners required to facilitate transactions outside their own area (European Union), etc. It is highly unlikely that these electric interconnections, characterized by vastly distinct transmission tariffs, obligations to the local customers, and current operating practices, would evolve into interconnections without boundaries at all. Therefore, it is essential that transmission access at the interconnection level be implemented keeping these differences in mind. As discussed by the inventors here and elsewhere (Ilic, et al., “Getting It Right the First Time: The Value of Transmission and High Technologies”, The Electricity Journal, November 1996), these seemingly inconsequential differences in open transmission access are actually critical. One needs an umbrella-type entity to seamlessly incorporate the tariff structures and the operating practices (including reliability reserves and requirements) of the individual entities. The framework disclosed herein meets this critical requirement.

Preferably, the information flow of FIG. 1 will be synchronized on a daily (T_{d}), weekly (T_{w}), monthly (Tₘ) and/or seasonal (Tₛₙ) time interval, but any time interval is contemplated.

A. Information Flow Between the IRTO and the Transmission Selling Entities (TPs, CAs, ISOs, Electricity Markets)

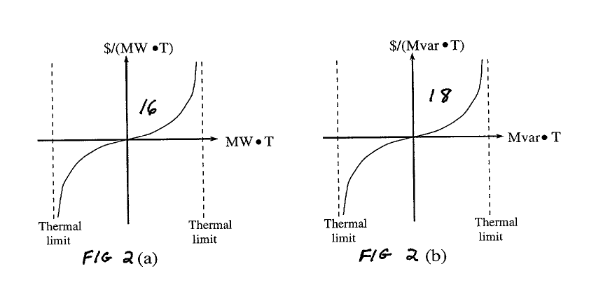

The basic information transmitted between the IRTO 10 and the selling entities 12 is in the form of bidding curves 16 and 18 as shown in FIG. 2A and FIG. 2B, respectively. One transmission bid curve 16 is characterized by the amount of real power in MegaWatts (MWs) that a transmission provider I is willing to send from its tie-line Tₖₙ^{I} connecting physical buses k and n to the rest of the interconnection and the corresponding price in Dollars/Megawatt ($/MW). Another transmission bid curve 18 similarly conveys the information about the amount and corresponding price of reactive power flow in MegaVars (MVars) that transmission provider I is willing to send from its tie-line to the rest of the interconnection.

This information must be given by all entities willing to provide tie-line flow control in order to facilitate the implementation of the inter-regional transactions.

B. Information Flow Between Purchasers of the IRTO Transmission Service and the IRTO

Information flows directly between purchasing entities 14 requesting inter-regional transaction implementation and the IRTO 10. It is not expected that the purchasers of transmission service communicate with the individual selling entities 12, even the providers with whom the transaction physically originates and/or ends.

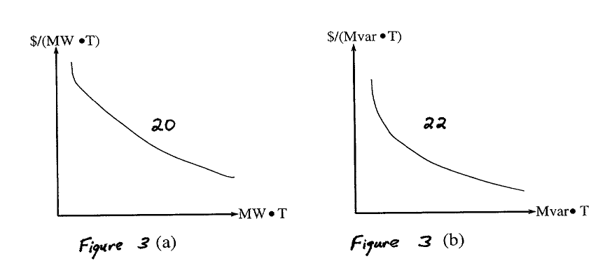

Purchasers provide their requesting bids in the form of demand curves 20 and 22 as shown in FIGS. 3A and 3B, respectively. The demand curve 20 relates the amount of real power F_{l,m} injected point-to-point from l to m and the price the purchaser is willing to pay to the IRTO 10 for this service. Shown in FIGS. 3A and 3B are examples of demand curves sent to the IRTO for real 20 and reactive 22 power transmission support, respectively.

A variety of demand curves are possible for serving a portfolio of requests to accommodate multilateral transactions, in which point-to-point specifications are replaced by the set of points to set of points specifications.

II. Market-Clearing Process by the IRTO

Disclosed here is a primary objective of the current invention, the market-clearing process occurring as the purchasing and selling entities exchange the information specified above. The process can be summarized as follows:

Step 1: By a selected and publicly known time interval [kT_{offer}], where k=0,1 . . . , the IRTO 10 collects all selling bids and all demand bids described above from all interested parties (12 and 14).

Step 2: The IRTO 10 iterates information with sellers and buyers between times [kT_{offer}] and [kT_{clearing}] in order to ensure clearing of supply (16 and 18) and demand (20 and 22) bids so that the tie-line flows (both real and reactive power) from one entity are the same (with negative sign) as from the receiving entity at the other physical end of the tie-line, i.e.

Fₖₙ^{I}=−Fₙₖ^{J} (Equation 1)

if the transmission providing entities I and J are directly adjacent with a tie line kn connecting them. Equation 1 must be met for all tie-line flows at the time [T_{clearing}] prior to implementing the bids. The bids for Fₖₙ^{I} and Fₙₖ^{J} are not identical curves initially. However, for the actual physical implementation, this is necessary. It is this requirement of Equation 1 that makes the clearing mechanism process challenging and qualitatively different than the clearing mechanism of traditional commodities. Described in a section below are the specific details of the clearing algorithm which the IRTO 10 will use for market clearing. Without this clearing algorithm, it would be quite difficult to clear the transmission provision market efficiently.

Step 3: The IRTO 10 communicates to the selling 12 and purchasing 14 entities the amounts the tie-line flow quantities (real and reactive power tie-line flows) and corresponding prices at the clearing time. Each purchasing entity 14 is given the price pₗₘ for implementing its transaction between points l and m, and the quantity it is allowed to inject. Similarly, each selling entity 12 I is given the actual flows Fₖₙ^{I} and the corresponding payments for maintaining the tie-line flows at these levels. This information is given to all selling 12 and purchasing 14 entities simultaneously by the IRTO 10.

Step 4: The transmission market for implementing inter-regional transactions clears, and in the next time interval, the IRTO 10 ensures/checks that all transmission contracts of this interval were implemented as agreed upon.

Step 5: Set $k=k+1$ and go to Step 1.

These steps may be accomplished manually by the IRTO 10, but it is preferable to employ a computer adapted to execute stored instructions, including the instructions of the clearing algorithm, and communicate via a communications network to the purchasing 14 and selling 12 entities.

A. Underlying Technical Concept

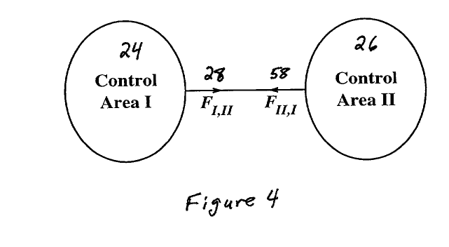

The IRTO 10 performs strict static control of tie-line flows (real and reactive) based on the available bids for selling transmission provision and buying it on the inter-regional basis. FIG. 4 shows a simple case of tie-line flow 28 between a control area I 24 and a control area II 26.

As a result of the achieved strict static control, two important objectives are met. First, the setting of tie-line flow targets for the following week, month and/or season (or other interval) is not determined by the system operators and their inflexible nomograms; instead, they are determined by the supply and demand specifications for this service. Second, the flexibility of this approach to control results in only slight deviations in tie-line flows; the demand for transmission by the inter-regional transactions 14 is met by the transmission providers 12 acting to meet exactly their demand at an optimal price. Consequently, except under some very unusual circumstances, tie-line flows are unlikely to approach the limits that would endanger the system integrity.

In some rare situations, the IRTO 10 has the ultimate authority to deny access to some inter-regional transactions 14 to avoid thermal, voltage and/or inter-area oscillation problems. By design, these situations are rare exceptions and the IRTO's performance and/or profit will be dependent upon its reliable implementation of committed transactions.

It is expected that the TPs, CAs, ISOs and other similar transmission providing entities 12 will attempt to dynamically maintain the committed tie-line flow levels during each period. Depending upon the nature of the transmission providing entity, it could rely either on its internal generators and load-serving entities to regulate the tie-line flow at the value assigned by the IRTO at the time of inter-regional transmission market clearing, and/or could use various transmission technologies for direct flow control by means of Flexible AC Transmission Systems (FACTS, U.S. Pat. No. 5,517,422 to Ilic, et al., herein incorporated by reference) and/or voltage control devices (this limit is often the critical one). Moreover, transmission providing entities will begin to deviate from the very conservative preventive operating mode to relying more on corrective actions/control in order to make higher profit with the same capital equipment. The value of transmission control technologies will finally begin to be based on financial incentives, a critically missing piece in a monopolistic transmission provision. If the IRTO has a seasonal mechanism, it may help provide incentives for investments into transmission facilities for facilitative large inter-regional transactions as markets evolve.

B. Tie-Line Flow Control Example & Market-Clearing Algorithm

An embodiment comprising a simple case of two control areas, I 24 and II 26, connected via a tie-line 28 is shown in FIG. 4.

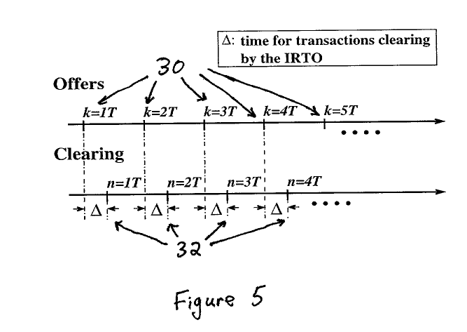

A representation of the time line for receiving and clearing offers for inter-regional transactions is shown in FIG. 5. At each increment k 30 of the selected time interval T, where each k=1, 2, . . . , and where T is preferably a day, week, month, and/or season, the IRTO 10 collects all bids from both users of the tie-line flows (IRTs 14) and the sellers of tie-line flow control (individual control areas I 24 and II 26 as shown in FIG. 4.) The offers are made by each time interval k and are cleared by the IRTO at each time n 32 as shown in FIG. 5.

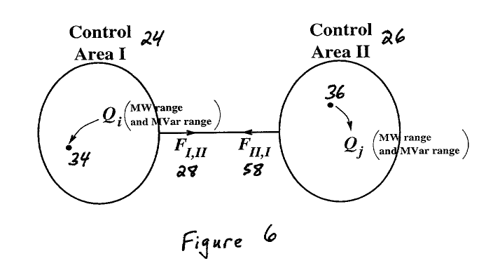

FIG. 6 is a further abstraction of the two control area embodiment illustrating an injection 34 and withdrawal 36 pair for inter-regional transactions. Hereinafter, this injection/withdrawal pair is referred to as a simple buyer of tie-line flow capacity Qᵢⱼ (“point-to-point”).

The purchasing entities' 14 demand specifications are made at each kT_{offer}, subject to k=1, 2, . . . ;

location of injection i 34 is within control area I 24;

location of withdrawal j 36 is within control area II 26; and

the power profile is to be injected (range) between points i 34 (into) Qᵢ and j 36 (taken out) Qⱼ for the following period.

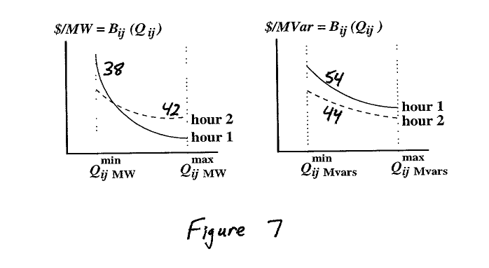

The power demands are preferably specified as real 38 and reactive 54 power demand curves as shown in FIG. 7. As shown in FIG. 7, at each kT_{offer}, the demand curves could vary within shorter intervals. For example, for a time interval of T_{offer}=1 day, real 42 and reactive 44 demand curves varying by an hour could be provided.

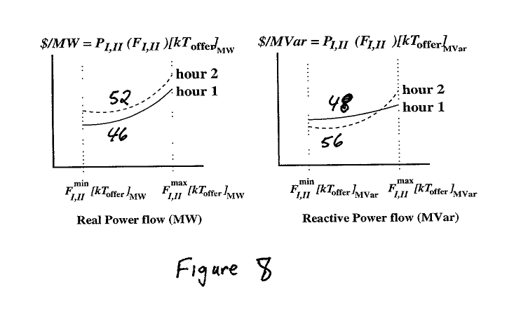

FIG. 8 shows the real 46 and reactive 48 supply curves of control areas I 24 and II 26. As is the case with demand curves, for each kT_{offer} the supply curves could vary within shorter intervals. For example, for a time interval of T_{offer}=1 day, real 52 and reactive 56 supply curves varying by an hour could be provided.

Upon receipt of all selling 12 and purchasing 14 entities' supply and demand bid curves, the IRTO 10 will apply a clearing algorithm to clear the bids. The algorithm may be applied manually, but preferably the computer system recited above would be employed to facilitate the calculations. The clearing algorithm solves the following optimization problem for the IRTO as it clears the bids:

$${min}_{{F}_{( \cdot )}^{S} , {Q}_{( \cdot )}} E \{ {\sum }_{k = 1}^{N} {( {F}_{I , II}^{S} [ k T ] - {F}_{I , II}^{D} ( U ( {Q}_{i j} [ k T ] ) ) )}^{2} {k}_{I , II} [ k T ] + \text{:} Term I \\ {( {F}_{II , I}^{S} [ kT ] - {F}_{I , II}^{D} ( U ( {Q}_{i j} [ k T ] ) ) )}^{2} {k}_{II , I} [ k T ] + \text{:} Term II \\ {p}_{I , II}^{2} ( {F}_{I , II}^{S} [ kT ] ) {r}_{I} [ k T ] + {p}_{I , II}^{2} ( {F}_{II , I}^{S} [ kT ] ) {r}_{II} [ kT ] - \text{:} Term III \\ {\sum }_{i j} {r}_{i j} {B}_{i j}^{2} ( {Q}_{i j} [ k T ] , k T ) \} \text{:} Term IV$$

subject to

F_{I,II}^{D}[(k+1)T]=F_{I,II}^{D}[kT]+DF_{factor}^{I,II}[kT]·(Qᵢⱼ^{D}[(k+1)T]−Qᵢⱼ^{D}[kT]) (Eq. 3)

F_{I,II}^{D}[(k+1)T]=F_{II,I}^{D}[kT]+DF_{factor}^{II,I}[kT]·(Qᵢⱼ^{D}[(k+1)T]−Qᵢⱼ^{D}[kT]) (Eq. 4)

for F_{I,II} 28, F_{II,I} 58, and Qᵢⱼ within the limits specified by the offers (defined as functions). The purpose of the clearing algorithm is to minimize the sum of:

deviations between the tie-line flow 28 created by control area I 24 (supplied by this area, F_{I,II}^{S}[kT]) and the tie-line flow created by all the inter-regional transactions Qᵢⱼ[kT] resulting in tie-line flow F_{I,II}^{D}[kT] (Term I)

deviations between the tie-line flow 58 created by the control area II 26 (supplied by this area, F_{II,I}^{S}[kT]) and the tie-line flow created by all the inter-regional transactions Qᵢⱼ[kT] resulting in tie-line flow F_{II,I}^{D}[kT] (Term II)

a charge related to (a) the price of tie-line flow control, p_{I,II}²(F_{I,II}^{S}[kT])r_{I}[kT] by area I 24, and (b) the price of tie-line flow control p_{II,I}²(F_{II,I}^{S}[kT])r_{II}[kT] by the area II 26 (Term III)

a benefit (negative charge) related to the use of tie-line flows paid by all the inter-regional transactions

$${\sum }_{i j} {r}_{i j} {B}_{i j}^{2} ( {Q}_{i j} [ k T ] , k T ) \qquad ( Term IV )$$

all weighted.

This minimization is subject to a technical flow law based on a Kirchhoff Current Law, but done in a very clever way—aggregation relates only to the impact of injections 34 Qᵢⱼ[kT] on the tie line flows. For a two control area case, the derivation of Equations (3) and (4) is straightforward. For a multiple number of control areas, one skilled in the art should be able to extrapolate, based on the concepts provided herein and supplemented by concepts found in the inventor's text “Hierarchical Power Systems Control” (Ilic, et al., Springer, 1996), which is herein incorporated by reference.

The clearing process is based on the formula which recognizes that the problem in Equation (2) is a Linear Quadratic Gaussian problem of finding optimal output control. It takes the form of

$$[ \begin{matrix}{F}_{I , II}^{S} [ k {T}_{clearing} ] \\ {Q}_{i j}^{D} [ k {T}_{clearing} ]\end{matrix} ] = [ \begin{matrix}{G}_{( I , II ) ( I , II )}^{S} [ k {T}_{clearing} ] & {G}_{( I , II ) ( II , I )}^{S} [ k {T}_{clearing} ] \\ {G}_{( i j ) ( I , II )}^{S} [ k {T}_{clearing} ] & {G}_{( i j ) ( II , I )}^{S} [ k {T}_{clearing} ]\end{matrix} ] \cdot \\ [ \begin{matrix}{F}_{I , II}^{D} [ k {T}_{clearing} ] \\ {F}_{II , I}^{D} [ k {T}_{clearing} ]\end{matrix} ] \qquad ( Eq , 5 )$$

where G(.) is the optimal co-efficients/constants or gain scheduling.

Variations may occur in cases in which different weights are given to terms in Equation (2) related to the quality of tie-line flow control k_{I,II} and k_{II,I} versus price of control r_{I}, r_{II}, and r_{III}.

C. Optimal (Bottom-Up) Bidding of a Supply Function by a Selling Entity to Control F_{I,II}^{S}[kT]

To achieve optimal bidding of a supply function for a selling entity, F_{I,II}^{S} is replaced by a generator of unknown cost, but assumed form c_{F}(P_{F})=a_{F}P_{F}²+b_{F}P_{F}+c_{F} and the following problem is to be solved

$${min}_{{P}_{F} [ kT ] , {ω}_{G}^{ref} [ k T ]} E \{ {\sum }_{k = 1}^{T / {T}_{d}} {\sum }_{{G}_{i}} {c}_{i} ( {P}_{{G}_{i}} ) + {c}_{F} ( {P}_{F} [ kT ] ) + ( {{l}^{T , I} ( {P}_{{G}_{i}}^{I} [ k T ] - {P}_{F} [ k T ] )}^{2} {w}_{I} \}$$

subject to

P_{G}[(k+1)T]=(I−K_{P}σT)P_{G}[kT]+K_{P}(I−σD)Tω_{G}^{ref}[kT]−σ(f[kT]−D_{P}d_{S}[kT]

This problem results in

u_{i [kT]=ω}_{G}^{ref}[kT]=G_{S}(l^{T,l}P_{G}^{U}[kT]−Fₑ^{I}[kT])

where Fₑ^{I}=F_{F}^{l}+D_{P}^{I}F_{L}^{I} and G_{S} are obtained using Ricatti's equation. Here Kₚ, σ, and D reflect the transmission parameters and topology of the selling entity (only) and the generators in the area (Ili, M., et al., Hierarchical Power Systems Control, Springer. 1996). Then repeat this optimization process for parametric choices of a_{F}, b_{F}, and c_{F}.

D. Optimal (Bottom-Up) Bidding of a Demand Function for Qᵢⱼ[kT] by an Interaction Variable (well-known)

The Qᵢⱼ[kT] will bid a demand curve whose benefit is related to the equation E{Bᵢⱼ²(Qᵢⱼ)[kT]−pᵢⱼ(Qᵢⱼ)Qᵢⱼ}. The value of tie-line flow control F^{D} caused by the injection Qᵢⱼ is measured is the expected gain from implementing Qᵢⱼ in the energy market over the contract duration.

If the selling and purchasing entities follow the optimum bidding strategies disclosed above, and the IRTO applies the clearing mechanism also disclosed above, the tie-line flow control system embodied herein should achieve an overall optimum market efficiency within in an environment of reduced information at the system level.

III. System & Method for Reliability Management

It is another objective of this invention to introduce a basis for non-uniform reliability provision depending on the type of regulatory and tariff structure of individual entities within the interconnection. The embodiments described above no longer observe unconditionally the (N−1) security criteria. Instead, reliability provisions are function of regulatory structures and the corresponding tariffs.

The invention disclosed herein allows for non-uniform management of reliability requirements by the individual entities to accommodate the regulatory/tariff structure most appropriate for themselves. The following is a list of several typical transmission providing entities, whose management of reliability is likely to differ considerably due to their varied structures.

A vertically integrated utility/transmission provider is characterized by a responsibility to meet (N−1) type reliable service to its own “native” customers. Consequently, this type of transmission provider participates in tie-line flow control through an IRTO only to the extent that it has sufficient stand-by reserve for its own customers.

A transmission provider which is corporately and functionally separate from the local generation and load-serving entities does not have a priori (implied) obligation to serve “native” customers in any different way than the outside the area inter-regional transaction users. In case a transmission line outage takes place, the local customers have no priority. Contractual arrangements must be made at the IRTO level for a reliable service of all, inter-regional and local customers.

A traditional control area without any a priori obligations to provide reserve in case of large equipment outage.

An ISO/Power Exchange type electricity market with variations of ways to provide stand-by resources in case of contingencies. The most typical is either a requirement for each participant in the energy market to provide certain percent stand-by reserve (PJM-ISO, NE-ISO), or a separate reserve market (CA-ISO)

Since the vertically integrated utilities have full responsibility to serve their own customers, they must provide enough reserve to do so in an independent way, without relying on other entities. They could, in addition, participate in the IRTO's managed agreements for reliable service and ensure that their customers are served from other resources. IRTs, on the other hand, do not have any provision for reliable service and should work out their terms with the IRTO. A contractual agreement between the IRTO and an IRT defining, for example, the number of times and conditions under which the transaction could be interrupted becomes a matter of risk-taking agreement between these two parties. Similarly, an agreement between transmission providers and the IRTO to supply available transmission capacity should provide specific terms under which the delivery could be interrupted. This, again, becomes a matter of risk taking between these parties.

A. Improved Secondary Level Control

An aspect of the invention disclosed herein is to allow improved secondary level control over tie-line flow. This includes ensuring in control area I 24, for example, tie-line flow control F_{I,II}^{S} independent from control area II 26. This is accomplished by means of its internal resources (generation) and/or by direct flow control using FACTS.

In the two-area embodiment (FIG. 6) described above, deviations in F_{I,II}^{S}[n] for all n=1, 2, . . . , 24, within [kT] and [(k+1)T] from the committed value F_{I,II}[kT] will be driven by the changes in the “native” (control area I 24) load, i.e. P_{L}^{l}[n+1]−P_{L}^{I}[n] and/or deviations in the flow F_{II,I}[n] created by the imbalances in the neighboring control area II 26, as well as by the deviations in injection at i or withdrawal at j of the inter-regional transactions, i.e. Qᵢⱼ[n+1]−Qᵢⱼ[n]. Since this deviation in inter-regional transactions is separable from P_{L}_{_{I}}[n+1]−P_{L}_{_{I}}[n ], it is not essential to treat it through a different mechanism.

The net imbalance can be expressed using the interaction variable, z^{I}=l^{T,I}P_{G}^{I} z^{I}[n+1]−z^{I}[n]=−l^{T,I}(Fₑ^{I}[n+1]−Fₑ^{I}[n]−D_{P}^{I}(P_{L}^{I}[n+1]−P_{L}^{I}[n])), where l^{T,I}K_{P}^{I}=0 and Fₑ^{I}=F_{G}^{I}+D_{P}^{I}F_{L}^{I}. The interaction variable refers to the variables composed of any linear combination of states in the area z[k]=Tx[k] that satisfies z[k+1]−z[k]=0 for ∀k, when any secondary level control law and in the absence of interactions among regions and the disturbances, i.e. f=0, dₛ=0.

A secondary level control law of the form

u^{I}=G_{P}^{U}(z^{I}−z^{I,ref})

u^{I}=G_{P}^{I}(z^{I}−z^{I,ref}) (Equation 6)

will maintain the net imbalance out of control area I at its reference value z^{I,ref}[kT].

If this is set to F^{I,II}[kT], the control law of Equation (6) will maintain the flow at this level. Its implementation could be by a FACTS device which compares z^{I} measured (l^{T,l}P_{G}^{I}) to z^{I,ref}[kT], or by a secondary level market maker who purchases l^{T,l}P_{G}^{I} necessary to maintain z^{I}[n]≈z^{I,ref}[kT]. If each CA follows the control law of Equation (6), the net tie-line flows will be maintained at F[kT]. Note: In the case of 2 CA's only, one needs to do this. Generally, (n−1) CA's need to control their interaction variables and the last will be automatically controlled.

For maintaining reactive power tie-line flows, an analogy to the formulae above may be made, being aware that the interaction variables are generally vectors (not scalars).(Ili , let al., Hierarchical Power Systems Control, Springer. 1996).

B. Optimal Tariffs by the IRTO

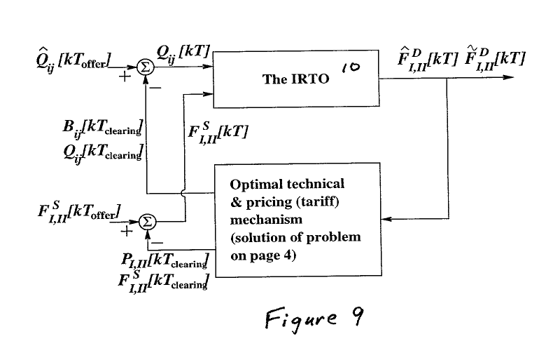

FIG. 9 is a block diagram displaying the functions which the invention disclosed herein will enable the facilitating IRTO to accomplish. Adherence to this system will allow an optimal tariff schedule for facilitating implementation of inter-regional transactions. There are three important and distinct times involved in the method, specifically T_{offer}, T_{clearing}, and T_{actual}. In the preferred embodiment, these times are synchronized by the system the IRTO is employing, but one skilled in the art should easily envision an alternative embodiment where entities are served as requested.

Another aspect of the present invention is the assurance by the IRTO of reliable power delivery at the inter-regional level. The need for coordination for reliability is very critical, as easily documentable based on the current operating practices. Recently, it has been recognized that the newly evolving entities may no longer perform power studies in a cooperative way. This has led to the formation of so-called security coordinators [e.g., NERC]. It should have not come as a surprise that the security coordinators were bound not to be economically efficient as measured by the energy market needs. The result of lack of effective software tools for which is further enriched to ensure that the system integrity remains intact.

Open access dictates a new concept of reliability. Instead of an unconditional service to all customers when a single equipment outage occurs (current operating/planning industry standard, i.e. so-called (n−1) security criterion [NERC]), electricity under open access is provided through contractual agreements between so-called load serving entities (LSEs) and the users according to well-defined terms on quality of service. As the LSEs of the future are forming, the existing utilities (distribution companies) have contractual obligations typically with their “native” customers to deliver electricity to them, even under certain equipment outages. It is for this commitment that the electric power system (generation, transmission and distribution) is built in a redundant way.

In the framework disclosed herein, reliability arrangements are well-defined at each selling entity level with its native customers. A seller of tie-line flow control effectively provides service to the LSEs, which purchase generation from outside their local area (these are effectively IRTs) by selling to the IRTO and the IRTs purchasing from the IRTO. This allows for non-uniform reliability commitments between each selling entity (into IRTO) and its local purchasers of service and at the same time for selling the remaining tie-line flow control to the IRTO after its obligation to the native customers is taken into consideration.

The IRTO, modifies all the bids, taking reliability into consideration for tie-line flow control, and takes all the bids from purchasing entities of tie-line flow control by the IRTs, similarly modifies them for reliability, and performs a market clearing function similar to the one specified in the basis method described in this patent. The IRTO will make some profit or incur losses depending on how well it clears the bids for reliability. A previous lack of financial incentives has resulted in an unacceptably high number of curtailed inter-regional transactions. This situation clearly points to the need for an entity with sufficient financial incentives to manage reliability at the inter-regional level as the IRTs are implemented.

The IRTO provides these as a natural extension of managing inter-regional transactions through (1) a careful contractual arrangements which specify reliability rules, rights and responsibilities for both sellers and purchases of the tie-line flow use, (2) development of software with dedicated to ensuring reliable performance of the transmission system as a whole even under unexpected equipment outages, and (3) a market clearing mechanism similar to the basic mechanism for implementing IRTs (reliability) related risks are distributed among the sellers of tie-line flow control (TPs, CAs, ISOs), purchasers of tie-line flow control (IRTs) and the IRTO itself through contractual specifications of supply and demand function in case contingencies occur.

Based on this generalized notion of reliability provision under open access, the IRTO:

Establishes well defined contractual agreements with the sellers and purchasers of tie-line flow control in case equipment outage takes place; and

Engages into software development which identifies likely reliability problems and software tools for coming up with optimal corrective actions to eliminate these.

It is a very straightforward matter to understand that if IRTO clears reactive power tie-line flow control bids according to the supply functions and demand functions as described earlier, no voltage problem will take place at the inter-regional level (currently, this is one of the major problems with the Eastern United States under large long-distance inter-regional transactions).

Similarly, the problem of inter-area oscillations would be eliminated automatically under the tie-line flow control proposed in the main market clearing mechanism. The only reliability specific modification of the market-clearing algorithm disclosed herein is in solving a stochastic optimization version of the same problem (thus the expectation operator E{•}), so that the expected outcomes under uncertain equipment outages are optimized, i.e.

$${min}_{{F}_{( \cdot )}^{S} , {Q}_{( \cdot )}} E \{ {\sum }_{k = 1}^{N} {( {F}_{I , II}^{S} [ k T ] - {F}_{I , II}^{D} ( U ( {Q}_{i j} [ k T ] ) ) )}^{2} {k}_{I , II} [ k T ] + \text{:} Term I \\ {( {F}_{II , I}^{S} [ kT ] - {F}_{I , II}^{D} ( U ( {Q}_{i j} [ k T ] ) ) )}^{2} {k}_{II , I} [ k T ] + \text{:} Term II \\ {p}_{I , II}^{2} ( {F}_{I , II}^{S} [ kT ] ) {r}_{I} [ k T ] + {p}_{I , II}^{2} ( {F}_{II , I}^{S} [ kT ] ) {r}_{II} [ kT ] - \text{:} Term III \\ {\sum }_{i j} {r}_{i j} {B}_{i j}^{2} ( {Q}_{i j} [ k T ] , k T ) \} \text{:} Term IV$$

subject to earlier constraints plus the uncertainty in equipment status (i.e. outages).

If

$$J = {\sum }_{k = 1}^{N} {( {F}_{I , II}^{S} [ k T ] - {F}_{I , II}^{D} ( U ( {Q}_{i j} [ k T ] ) ) )}^{2} {k}_{I , II} [ k T ] + \\ {( {F}_{II , I}^{S} [ kT ] - {F}_{I , II}^{D} ( U ( {Q}_{i j} [ k T ] ) ) )}^{2} {k}_{II , I} [ k T ] + \\ {p}_{I , II}^{2} ( {F}_{I , II}^{S} [ kT ] ) {r}_{I} [ k T ] + {p}_{I , II}^{2} ( {F}_{II , I}^{S} [ kT ] ) {r}_{II} [ kT ] - \\ {\sum }_{i j} {r}_{i j} {B}_{i j} ( {Q}_{i j} [ k T ] , k T )$$

then by replacing the optimization problem to include

$${min}_{{F}_{( \cdot )}^{S} , {Q}_{( \cdot )}} E \{ J + κ var ( J ) \}$$

where κ expresses the degree of risk aversion, a further generalization is possible in which the expected outcome is optimized so that the risk is controlled as well. The level of risk to be taken is determined by the IRTO itself. The problem becomes a LQG problem of Dynamic Programming problem (Bertsekas, D. Dynamic Programming and optimal Control, Athena Scientific, 1987). The level of risk by the selling entities and the purchasing entities is controlled as they offer contractual terms on their supply and demand functions. For example, a typical supply function for the selling entity would be created by also solving

$${min}_{{P}_{F} [ kT ] , {ω}_{G}^{ref} [ k T ]} E \{ {\sum }_{k = 1}^{T / {T}_{d}} {\sum }_{{G}_{i}} {c}_{i} ( {P}_{{G}_{i}} ) + {c}_{F} ( {P}_{F} [ kT ] ) + ( {{l}^{T , I} ( {P}_{{G}_{i}}^{I} [ k T ] - {P}_{F} [ k T ] )}^{2} {w}_{I} \}$$

subject to the earlier constraints plus the uncertainty in equipment status (i.e. outages). Similarly

$$S = {\sum }_{k = 1}^{T / {T}_{d}} {\sum }_{{G}_{i}} {c}_{i} ( {P}_{{G}_{i}} ) + {c}_{F} ( {P}_{F} [ kT ] ) + ( {{l}^{T , I} ( {P}_{{G}_{i}}^{I} [ k T ] - {P}_{F} [ k T ] )}^{2} {w}_{I}$$

then by replacing the optimization problem to include

$${min}_{{P}_{F} [ kT ] , {ϖ}_{G}^{ref} [ kT ]} E \{ S + η var ( S ) \}$$

where η expresses the degree of risk aversion of the selling entity in this case, a further generalization is possible in which the expected outcome is optimized so that the risk is controlled. In addition, to FIG. 2, a typical supply function for reliability-related specifications have a contractual specification that the selling entity will supply tie-line flow control within the specified range and not interrupt this contract more than certain pre-specified number of times during the contract duration. The demand function on the purchasing entity side would say that the IRT will purchase tie-line flow control and not get interrupted more than some number of times during the contract duration with the IRTO.

The IRTO has the ultimate burden of providing system-wide reliability at the market clearing conditions. Depending on the tools used, the IRTO may take different levels of risk itself in its obligations to the selling and purchasing entities, which, if not met, would imply financial penalties on the IRTO. This forces the IRTO to develop difficult software based on stochastic version of its basic market clearing mechanism. This is how the major value of software for coordinating value-based reliability is incentivized (which never was the case in the past). In addition, if the method is applied to IRTs for longer periods of time, it could be used for incentives for dynamic investments in order to keep desired reliability.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A tie-line flow control system comprising:
a computer having a central processor that executes instructions, a memory for storing the instructions to be executed, a means for communicating information; and
said instructions stored in the memory of the computer causing the central processor to:
receive request bid curves for inter-regional transactions from selling entities;
receive demand bid curves for inter-regional transactions from purchasing entities;
synchronize the bid curves at a selected time interval;
between synchronizing intervals, iterate information with the selling and purchasing entities to ensure clearing of supply and demand bids at a clearing time so that tie-line real and reactive power flows on the tie-lines interconnecting the selling entities are the same;
communicate to the selling and purchasing entities accepted tie-line flow quantities and corresponding prices at the clearing time; and
ensure that all inter-regional transactions clear as agreed upon in the previous synchronized interval.

2. The system of claim 1, wherein the clearing of supply and demand bids comprises application of a clearing algorithm minimizing, subject to a technical flow law based on Kirchoff s Current Law, a sum of:
deviations between tie-line flow controlled by the selling entities and tie-line flow caused by all inter-regional transactions;
a charge related to the price of tie-line flow controlled by the selling entities; and
a benefit related to the use of tie-line flows and paid by all inter-regional transactions.

3. The system of claim 1, wherein the purchasing entities comprise inter-regional transactions.

4. The system of claim 1, wherein the selling entities comprise transmission providers, control areas, and independent system operators.

5. The system of claim 1, wherein the selling entities comprise control areas only.

6. The system of claim 1, wherein the selected time interval may be hourly, daily, weekly, monthly and/or seasonally.

7. The system of claim 1, whereby the computer facilitates implementation of transmission contracts for purchasing entities.

8. The system of claim 1, whereby the computer provides coordinated reliability management through non-uniform reliability provisions which are a function of the selling entities' regulatory and an optimal tariff structure.

9. Method for tie line flow control among selling entities by an entity facilitating implementation of transmission contracts for purchasing entities, said entity executing the steps of:
receiving request bid curves for inter-regional transactions from selling entities;
receiving demand bid curves for inter-regional transactions from purchasing entities;
synchronizing the bid curves at a selected time interval;
between synchronizing times, iterating information with the selling and purchasing entities to ensure clearing of supply and demand bids at a clearing time so that tie-line real and reactive power flows on the tie-lines interconnecting the selling entities are the same;
communicating to the selling and purchasing entities accepted tie-line flow quantities and corresponding prices at the clearing time; and
ensuring that all inter-regional transactions clear as agreed upon in the previous synchronized interval.

10. The method of claim 9, wherein the clearing of supply and demand bids comprises application of a clearing algorithm minimizing, subject to a technical flow law based on Kirchoffs Current Law, a sum of:
deviations between tie-line flow controlled by the selling entities and tie-line flow caused by all inter-regional transactions;
the charge related to the price of tie-line flow controlled by the selling entities; and
the benefit related to the use of the tie-line flows and paid by all the inter-regional transactions.

11. The method of claim 9, wherein the purchasing entities comprise inter-regional transactions.

12. The method of claim 9, wherein the selling entities comprise transmission providers, control areas, and independent system operators.

13. The method of claim 9, wherein the selling entities comprise control areas only.

14. The method of claim 9, wherein the selected time interval may be hourly, daily, weekly, monthly and/or seasonally.

15. The method of claim 9, further comprising the step of providing coordinated reliability management through non-uniform reliability provisions which are a function of the selling entities' regulatory and an optimal tariff structure.

16. A method for optimizing an electricity transmission supply bidding curve for a selling entity.

17. A method for optimizing an electricity transmission demand bidding curve for a purchasing entity.

18. A method for optimizing coordination of transmission purchasing and selling entities in an open access environment.
